(19) United States
(12) Patent Application Publication
(10) Pub. No.: US 2008/0136396 A1
(43) Pub. Date: Jun. 12, 2008

(54) Voltage Regulator

(76) Inventor: Benjamin Heilmann, Raleigh, NC (US)

Correspondence Address: COATS & BENNETT/QIMONDA, 1400 CRESCENT GREEN, SUITE 300, CARY, NC, 27518, US

(21) Appl. No.: 11/567,327

(22) Filed: Dec. 6, 2006

(51) Int. Cl. G05F 1/652

(52) U.S. Cl. 323/298

(57) ABSTRACT

A voltage regulator is operated by determining if the voltage output by the voltage regulator is within a desired operating region and adjusting a feedback resistance associated with the voltage regulator when the voltage output by the voltage regulator is outside the desired operating region.

### BACKGROUND OF THE INVENTION

Various types of integrated circuits incorporate or otherwise use voltage regulators for generating constant voltage levels, e.g., constant reference voltages and/or supply voltages. Voltage regulators conventionally include an amplifier, a drive transistor and a feedback path between the output of the drive transistor and one input of the amplifier. The other amplifier input receives a reference voltage. During operation, the amplifier generates a signal proportional to the difference between the reference voltage input and the feedback voltage. The amplifier output actuates the drive transistor's gate. In response, the drive transistor outputs a voltage having a magnitude proportional to its gate voltage (i.e., the amplifier output).

The reference voltage input to a voltage regulator may be externally provided or generated “on-chip”, e.g., by a bandgap reference circuit. While bandgap reference circuits tend to be immune to process, voltage and temperature variations, voltage regulators are subject to various sources of variability. As such, the output of a conventional voltage regulator drifts or otherwise shifts during operation. For example, a temperature change may cause the output of a voltage regulator's drive transistor to drift or shift away from a reference voltage input. If the regulated voltage output falls outside an acceptable range, circuitry dependent upon the output of the regulator may operate undesirably.

Various sources may cause drift or shift in a voltage regulator's output. For example, layout mismatch as well as process, voltage and temperature variations cause a voltage regulator's output to vary. In addition, gain of the regulator's amplifier may also contribute to output shift. Particularly, amplifier gain determines how closely the feedback node of the drive transistor tracks a reference voltage input. High gain results in better tracking, but the circuit may be harder to stabilize under all operating conditions. Stabilizing the regulator circuit may decrease circuit performance. Conversely, low gain may provide better operational stability. However, low gain worsens tracking between the feedback node and the reference voltage input, thus increasing systemic offset between the drive transistor's output and the reference voltage input, further exasperating voltage output variation.

### SUMMARY OF THE INVENTION

According to the methods and apparatus taught herein, one embodiment of operating a voltage regulator comprises determining if a voltage output by the voltage regulator is within a desired operating region and adjusting a feedback resistance associated with the voltage regulator when the voltage output by the voltage regulator is outside the desired operating region.

Of course, the present invention is not limited to the above features and advantages. Those skilled in the art will recognize additional features and advantages upon reading the following detailed description, and upon viewing the accompanying drawings.

### BRIEF DESCRIPTION OF THE DRAWINGS

FIG. 1 is a block diagram of one embodiment of a voltage regulator circuit having adjustable feedback resistance.

FIG. 2 is a block diagram of another embodiment of a voltage regulator circuit having adjustable feedback resistance.

FIG. 3 is a plot illustrating the output of the voltage regulator circuit of FIG. 2.

FIG. 4 is a block diagram of yet another embodiment of a voltage regulator circuit having adjustable feedback resistance.

FIG. 5 is a plot illustrating the output of the voltage regulator circuit of FIG. 4.

FIG. 6 is a block diagram of one embodiment of a variable feedback resistor included in or associated with a voltage regulator circuit.

FIG. 7 is a block diagram of another embodiment of a variable feedback resistor included in or associated with a voltage regulator circuit.

FIG. 8 is a logic flow diagram of one embodiment of program logic for maintaining the output of a voltage regulator circuit within a desired operating range.

### DETAILED DESCRIPTION OF THE INVENTION

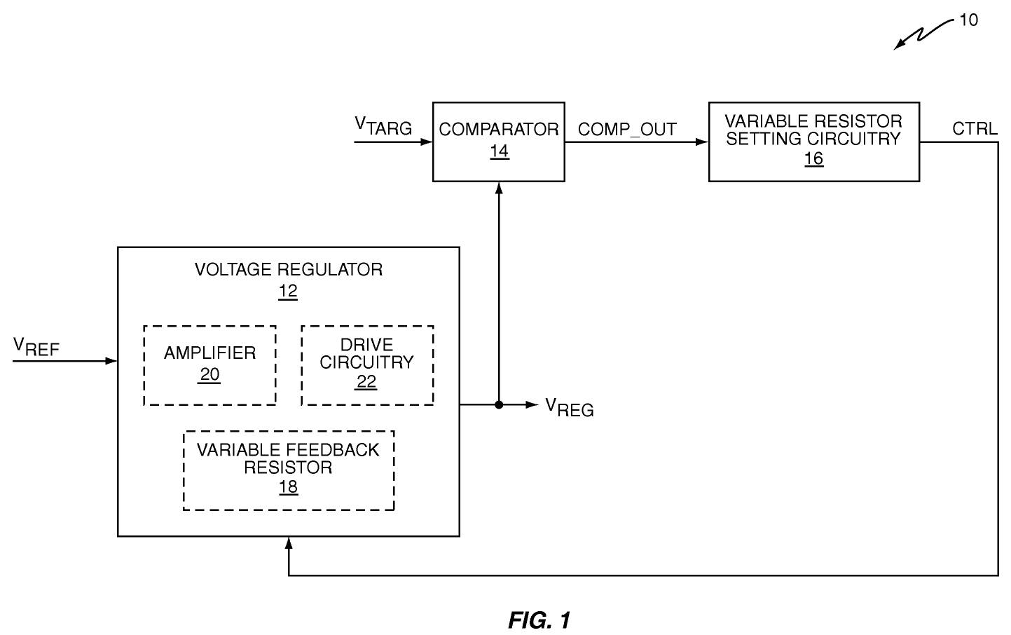

FIG. 1 illustrates an embodiment of a voltage regulator circuit 10 having adjustable feedback resistance. The circuit 10 includes a voltage regulator 12 such as a linear voltage regulator, a comparator 14 and circuitry 16 for setting the resistance of a variable feedback resistor 18 included in or associated with the voltage regulator 12. By setting the feedback resistance of the variable resistor 18 to an appropriate value, voltage output V_{REG} of the voltage regulator 12 may be maintained within a desired operating region regardless of variation in process, temperature, voltage, gain, current load, etc. As such, the output of the voltage regulator 12 does not drift or otherwise shift outside a desired operating region.

In more detail, the voltage regulator 12 comprises an amplifier 20 and drive circuitry 22 such as one or more transistors. During operation, the drive circuitry 22 generates relatively constant regulated voltage V_{REG} corresponding to the amplifier's output. V_{REG} is provided to one or more circuits (not shown) downstream of the voltage regulator circuit 10, e.g., as a supply or reference voltage. Drive circuitry 22 also generates a feedback voltage which is partly a function of the feedback resistance of the variable resistor 18. Depending on the configuration of the variable resistor 18, the feedback voltage may be either V_{REG} or a fraction of V_{REG}. The feedback voltage is provided to one input of the amplifier 20 while reference voltage V_{REF} is provided to the other input. Preferably, V_{REF} is relatively immune to process, voltage, temperature and/or other sources of variation, and thus, remains relatively constant. For example, V_{REF} may be externally generated or generated by a bandgap reference circuit (not shown).

Regardless, the output of amplifier 20 is proportional to the difference between V_{REF} and the feedback voltage. As such, amplifier 20 causes the drive circuitry 22 to adjust V_{REG} until the difference between V_{REF} and the feedback voltage is minimized. If V_{REG} equals or exceeds a predetermined limit, the variable feedback resistor 18 is adjusted in order to change the feedback voltage. Since the feedback voltage is a function of feedback resistance and V_{REG} is proportional to the difference between V_{REF} and the feedback voltage, V_{REG} may be maintained within a desired operating region by making appropriate adjustments to the variable feedback resistor 18.

The feedback resistance is adjusted by an amount sufficient to maintain V_{REG} within a desired operating region. For example, if the voltage regulator circuit 10 is subjected to high process, temperature, voltage, gain, and/or current load variation, the adjustment to the variable feedback resistor 18 is high. Conversely, if the regulator circuit 10 is subjected to little or no variation, the variable feedback resistor 18 is minimally adjusted or not adjusted at all.

To that end, V_{REG} is compared to target voltage information V_{TARG} by the comparator 14 or other comparable circuitry such as an operational amplifier without negative feedback. If V_{REG} equals or exceeds a limit indicated by V_{TARG}, the feedback resistance associated with the regulator 12 is adjusted accordingly. In one embodiment, V_{TARG} indicates a target regulated voltage. In another embodiment, V_{TARG} indicates a target range of regulated voltages. Regardless, the comparator 14 determines whether V_{REG} is within a desired operating region as indicated by V_{TARG}, where V_{TARG} may include tolerance. If V_{REG} equals or exceeds a limit indicated by V_{TARG}, the comparator 14 outputs a signal (COMP_OUT) that activates the variable resistor setting circuitry 16. Otherwise, the comparator output remains inactive.

The comparator output indicates whether the variable feedback resistor 18 is to be adjusted or not. In one embodiment, the comparator's output represents the magnitude in difference between V_{REG} and a limit indicated by V_{TARG}. In another embodiment, the comparator's output is only active (e.g., high or low) if V_{REG} equals or exceeds a limit indicated by V_{TARG}. Either way, the regulator's feedback resistance is adjusted by altering the control signal (CTRL) input to the variable resistor 18, the value of the control signal indicating a particular resistance associated with the resistor 18. Thus, when the comparator 14 indicates feedback resistance is to be adjusted, the variable resistor setting circuitry 16 modifies the variable resistor's control signal input accordingly. The new control signal is selected based on the comparator output. Accordingly, the output of the voltage regulator circuit 10 may be maintained within a desired operating region by modifying the control signal input to the variable feedback resistor 18.

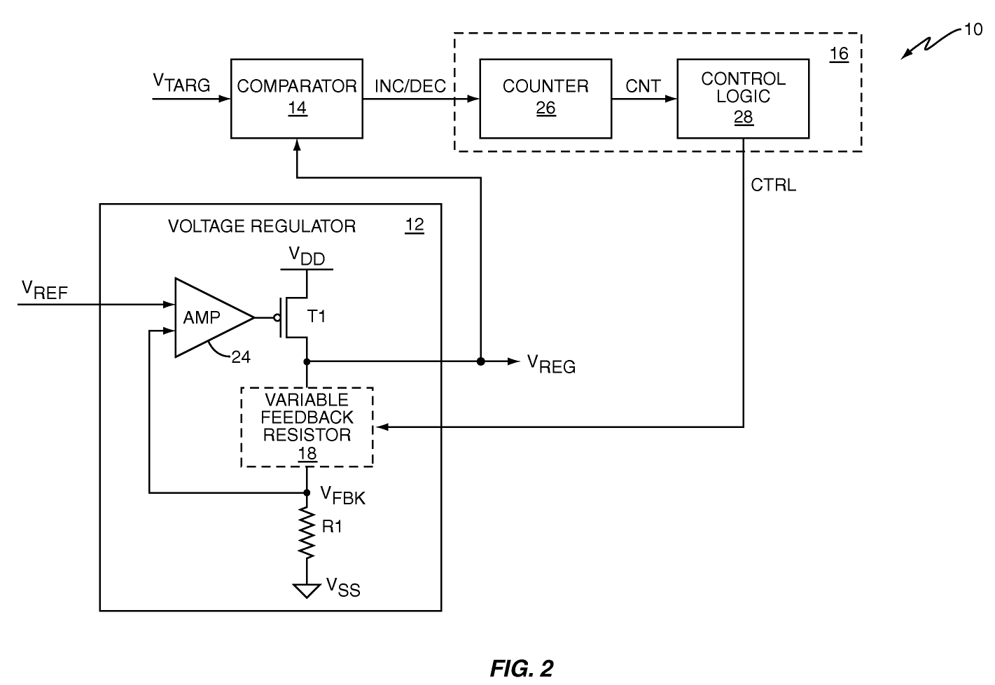

FIG. 2 illustrates one embodiment of the voltage regulator circuit 10. According to this embodiment, the voltage regulator 12 has a single voltage regulation stage including an amplifier 24, a drive transistor T1 and a fixed-precision resistor R1. Resistor R1 may comprise a doped region of a semiconductor substrate or one or more properly biased transistors. During operation, the amplifier 24 generates a signal proportional to the difference between reference voltage input V_{REF} and feedback voltage V_{FBK}. Drive transistor T1 outputs regulated voltage V_{REG} responsive to the amplifier output, where V_{FBK} is a function of V_{REG} and the regulator's feedback resistance. Comparator 14 compares V_{REG} with target voltage information V_{TARG} to determine whether V_{REG} is within a desired operating region as indicated by V_{TARG}. If V_{REG} falls outside the desired operating region, the variable resistor setting circuitry 16 adjusts the variable resistor's control signal input accordingly.

According to this embodiment, the variable resistor setting circuitry 16 comprises a counter 26 and control logic 28. The signal output by the comparator 14 corresponds to an increment/decrement count signal (INC/DEC) that activates the counter 26. When the counter 26 is active, it either increments or decrements its current count value (CNT) responsive to the state of the comparator output. Control logic 28 translates the current count value to a corresponding control signal value (CTRL). The particular value of the control signal determines the resistance of the feedback resistor 18.

In one embodiment, the control logic 28 accesses a table (not shown) and selects the control signal value corresponding to the current count value. In another embodiment, the control logic 28 comprises state machine logic configured to determine control signal values based on the current count value. Regardless, the variable resistor setting circuitry 16 may be synchronous, thus enabling it to increase (or decrease) its count responsive to the comparator output being active during successive clock cycles. Broadly, the variable resistor setting circuitry 16 may comprise any circuitry suitable for translating or otherwise converting the comparator output to control signal values. Thus, V_{REG} may be maintained within a desired operating region by setting the variable resistor's control signal input to an appropriate value.

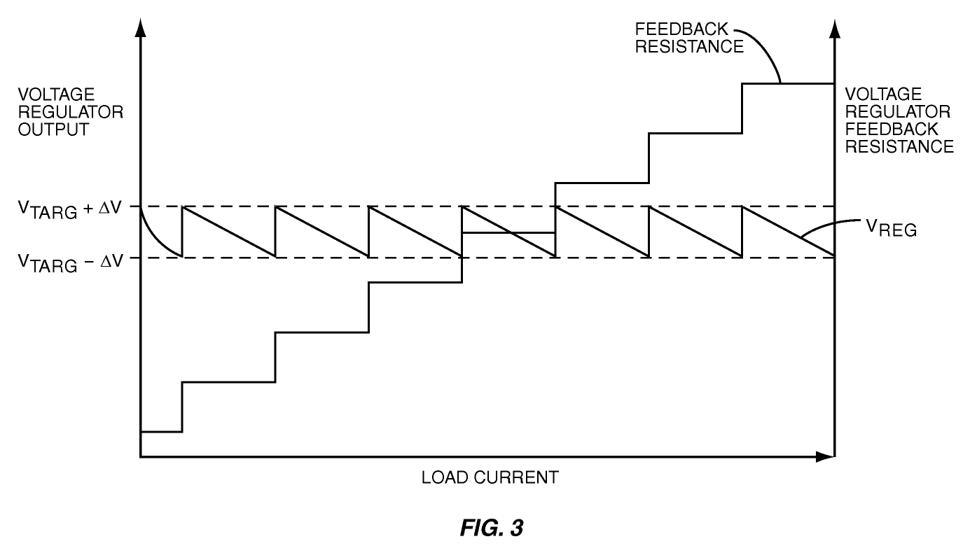

FIG. 3 provides an exemplary illustration as to how the voltage regulator circuit 10 shown in FIG. 2 maintains V_{REG} within a desired operating region despite changing load conditions by adjusting its feedback resistance accordingly. FIG. 3 plots load current (x-axis) versus voltage regulator output (primary y-axis) and feedback resistance (secondary y-axis). In the present illustration, the desired operating region corresponds to voltage values ranging between first and second predetermined voltage limits V_{TARG}+/−ΔV (plus tolerance). The voltage output by the regulator circuit 10 is maintained within the desired operating region by adjusting the regulator's feedback resistance when the regulator's output equals or exceeds V_{TARG}+/−ΔV.

For example, if the regulator's output equals or exceeds V_{TARG}+ΔV, the comparator 14 and variable resistor setting circuitry 16 cause the control signal input to the variable resistor 18 to be adjusted until the regulator's feedback resistance is sufficiently low, e.g., until V_{REG} is approximately equal to or below V_{TARG}+ΔV. By lowering the feedback resistance of the variable resistor 18, feedback voltage V_{FBK} increases. When V_{FBK} increases, the difference between V_{FBK} and reference input V_{REF} decreases, causing the amplifier 24 to reduce the gate voltage applied to drive transistor T1. Reducing the gate voltage of drive transistor T1 causes V_{REG} to decrease. As such, V_{REG} is maintained within the desired operating region despite decreasing load current by reducing the feedback resistance a sufficient amount.

Feedback resistance may be adjusted in a step-wise manner, e.g., by successively altering the control signal input to the variable resistor 18. For example, as the load current decreases, the regulator's feedback resistance is incrementally decreased to maintain V_{REG} within the desired operating region. Each step in V_{REG} corresponds to a successive reduction in feedback resistance responsive to a decrease in load current. Preferably, feedback resistance is incrementally adjusted in steps that result in V_{REG} changing less than twice AV. Otherwise, the regulator output may skip or jump over the desired operating region as indicated by V_{TARG}+/−ΔV.

Similarly, if the regulator's output equals or falls below V_{TARG}−ΔV, the comparator 14 and variable resistor setting circuitry 16 cause the control signal input to the variable resistor 18 to be adjusted until the regulator's feedback resistance is sufficiently high, e.g., until V_{REG} is approximately equal to or above V_{TARG}−ΔV. As load current increases, the regulator's feedback resistance is incrementally increased to maintain V_{REG} within the desired operating region. Each step in V_{REG} corresponds to a successive increase in feedback resistance responsive to an increase in load current. The regulator's feedback resistance is not adjusted when V_{REG} falls within the desired operating region as indicated by V_{TARG}+/−ΔV.

In the present illustration, the desired operating region corresponds to a range of voltage values bounded by first and second predetermined voltage limits V_{TARG}+/−ΔV (plus tolerance). However, the feedback resistance may be adjusted such that V_{REG} is maintained approximately equal to a single voltage limit (plus tolerance) instead of between upper and lower limits V_{TARG}+/−ΔV. Regardless, V_{REG} is maintained within a desired operating region for all load currents by adjusting the regulator's feedback resistance accordingly.

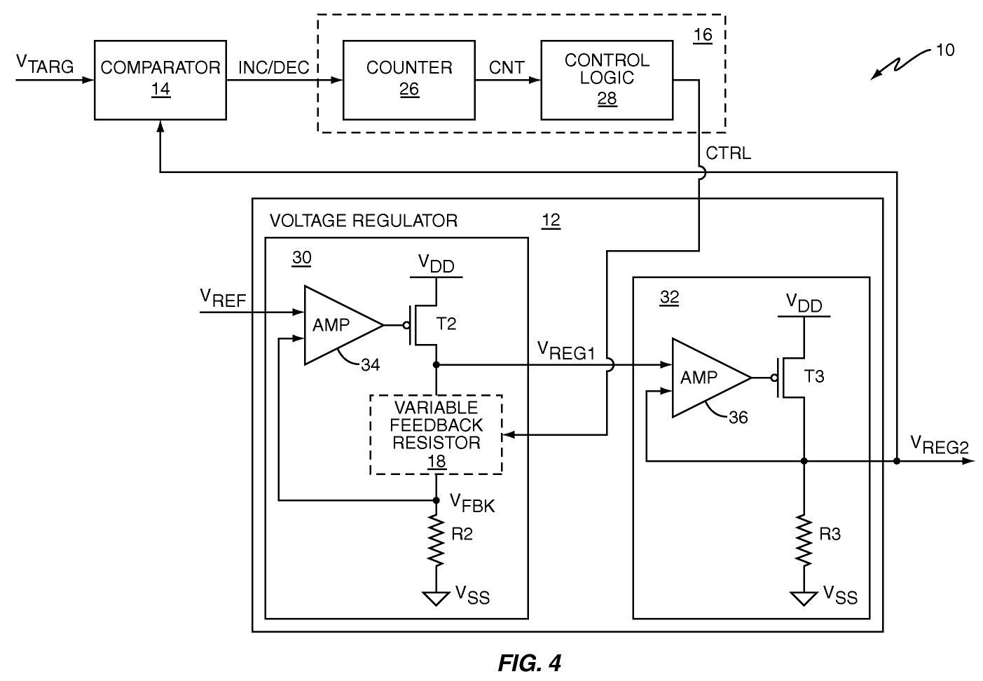

FIG. 4 illustrates another embodiment of the voltage regulator circuit 10. According to this embodiment, the voltage regulator 12 comprises first and second voltage regulation stages 30 and 32. First stage 30 yields regulated voltage output V_{REG1} which is a function of the first stage's feedback resistance as provided by variable feedback resistor 18. As a result, the first stage 30 outputs a regulated voltage which is a multiple of reference voltage input V_{REF}. Second stage 32 has no (or minimal) feedback resistance. As a result, the second stage's output tracks its input (V_{REG1}). During operation, first stage 30 operates as a voltage reference generator in that V_{REG1} may be trimmed to a desired value by altering its feedback resistance while the second stage 32 provides additional current drive capacity.

In more detail, first stage 30 includes an amplifier 34, a drive transistor T2 and a fixed-precision resistor R2. Variable feedback resistor 18 included in or associated with the first voltage regulation stage 30 sets the circuit's feedback resistance. The first stage 30 generates regulated voltage V_{REG1} and feedback voltage V_{FBK} where V_{FBK} is a function of the feedback resistance as previously described. Second stage 32 has an amplifier 36, a drive transistor T3 and a fixed-precision resistor R3. Second stage 32 does not have variable feedback resistance. Accordingly, V_{REG2} is approximately equivalent to V_{REG1}. The counter 14 and variable resistor setting circuitry 16 work to maintain regulated voltage V_{REG2} within a desired operating region as indicated by V_{TARG}.

If V_{REG2} falls outside a desired operating region, the comparator 14 indicates that the feedback resistance associated with the first voltage regulation stage 30 is to be adjusted. In response, the variable resistor setting circuitry 16 alters the control signal input to the first stage's variable resistor 18 based on the current count value (CNT) output by counter 26. The modified control signal determines the new feedback resistance. Accordingly, feedback resistance associated with the first stage 30 is adjusted to maintain the voltage output by the second stage 32 within a desired operating region. The embodiment illustrated in FIG. 4 reduces the adverse affects associated with process, temperature, voltage, gain, and/or current load variation while providing additional current drive capacity.

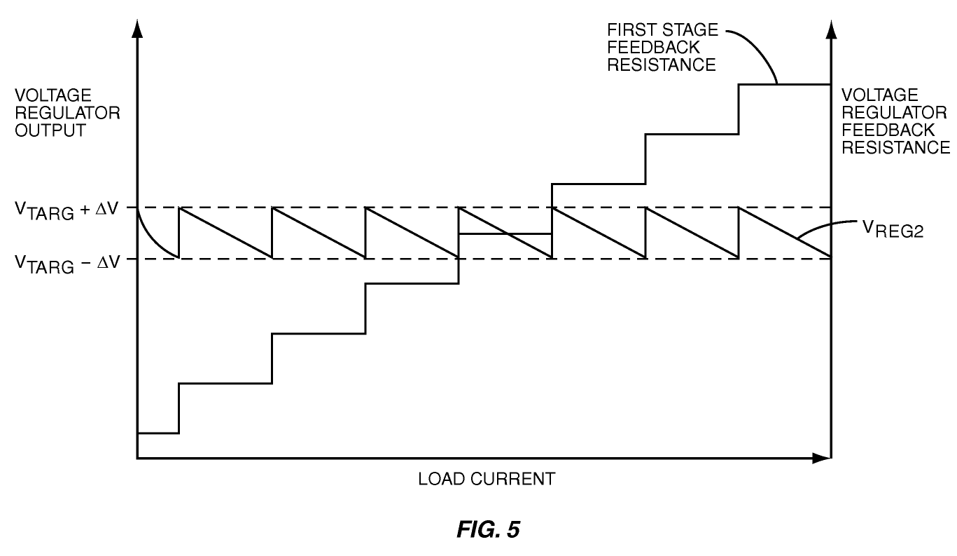

FIG. 5 provides an exemplary illustration as to how the voltage regulator circuit 10 illustrated in FIG. 4 maintains regulated voltage output V_{REG2} of the second regulation stage 32 within a desired operating region despite changing current load conditions. If a change in load current causes V_{REG2} to equal or fall outside V_{TARG}+/−ΔV, comparator 14 and variable resistor setting circuitry 16 cause the feedback resistance associated with the first stage 30 to be adjusted so that the output of the second stage 32 remains within the desired operating region. As can be seen in FIG. 5, regulated voltage output V_{REG2} is adjusted in a step-wise manner, each step corresponding to an adjustment in the feedback resistance associated with the first stage 30.

For example, when load current diminishes, the second stage's output (V_{REG2}) begins to drift toward an upper limit of the desired operating region as indicated by V_{TARG}+ΔV. In response, feedback resistance of the first stage 30 is successively decreased, causing a corresponding decremental step-wise change in V_{REG1}. Since the second stage 32 tracks the output of first stage 30, decreasing V_{REG1} causes V_{REG2} to decrease, thus maintaining the output of the second stage 32 within the desired operating region. Similarly, the first stage's feedback resistance is successively increased responsive to increasing load currents, causing a corresponding incremental step-wise change in V_{REG1}. As such, proper adjustments to the feedback resistance associated with first stage 30 cause V_{REG2} to remain within the desired operating region as indicated by V_{TARG}+/−ΔV.

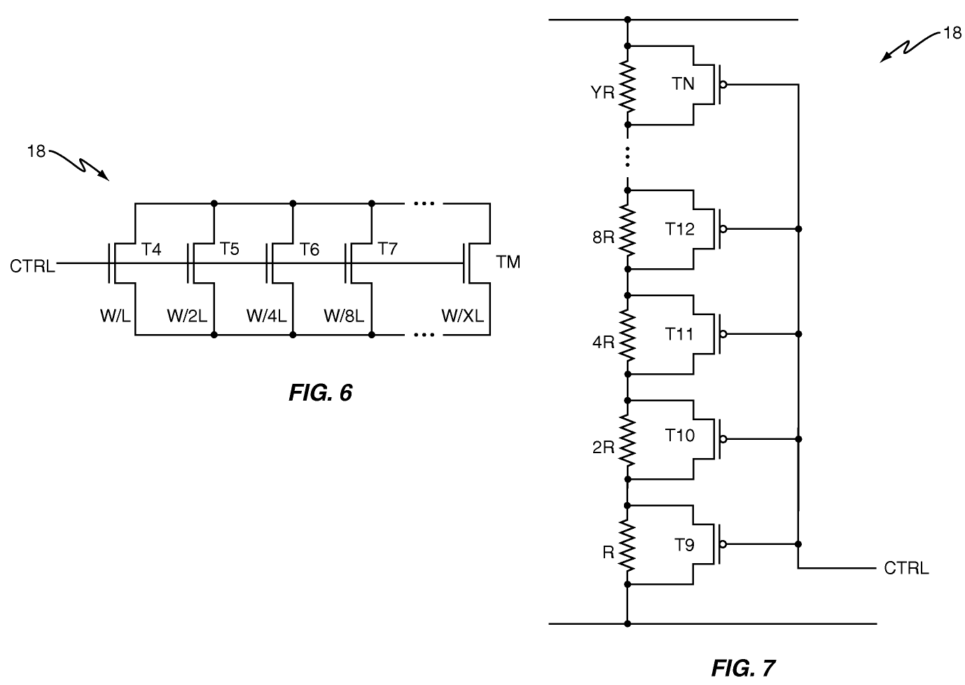

FIG. 6 illustrates one embodiment of the variable feedback resistor 18. According to this embodiment, the variable resistor 18 comprises a plurality of transistors T4 through TM electrically coupled in parallel. The resistance of each transistor is proportional to its length (L) and inversely proportional to its width (W). For example, as shown in FIG. 6, first transistor T4 has approximately half the resistance of second transistor T5, approximately one-fourth the resistance of third transistor T6 and so on. Desired resistance values may be achieved by appropriately sizing the transistors and activating selected ones of the transistors. Individual ones of the transistors are activated in response to the control signal (CTRL) input to the variable resistor 18. For example, the control signal may comprise a pattern of binary 1s and 0s indicating which transistors are switched on and which ones are not.

FIG. 7 illustrates another embodiment of the variable feedback resistor 18. According to this embodiment, the variable resistor 18 comprises a plurality of resistors R electrically coupled in series. Switches such as transistors T9 through TN determine whether respective ones of the resistors are switched into the resistive network. For example, the control signal (CTRL) input to the variable resistor 18 determines which transistors are switched on and which ones are not. The resistors may be formed from doped regions of a semiconductor wafer. Suitable resistance values may be achieved by forming resistors of varying dimension and selecting appropriate ones of the resistors to be included in the resistive network. Those skilled in the art will readily recognize that other kinds of variable resistors may be used to provide variable feedback resistance to the voltage regulator circuit 10, and thus, are within the scope of the present invention.

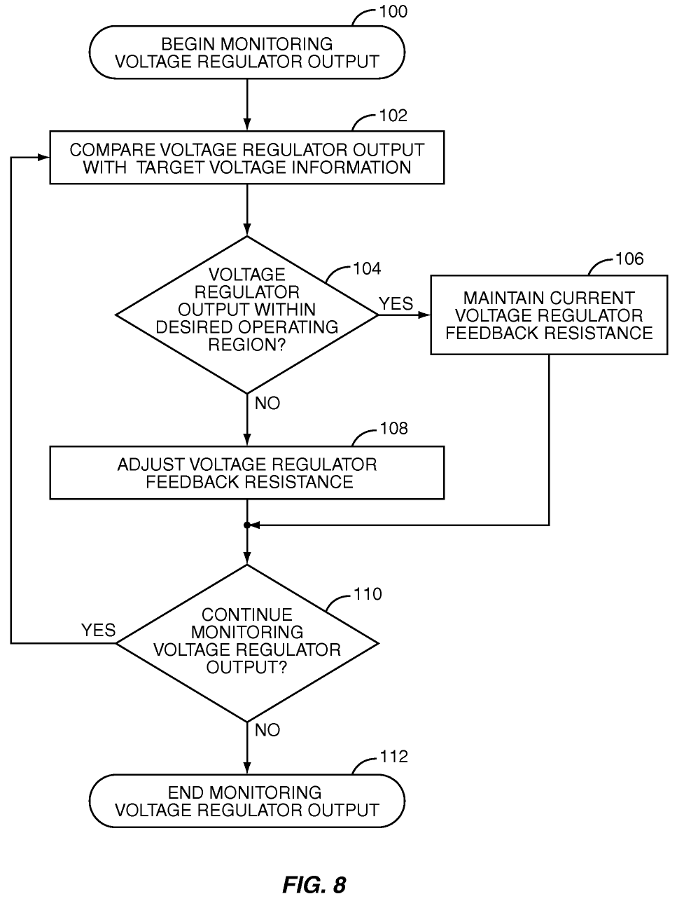

FIG. 8 illustrates one embodiment of program logic for maintaining the output voltage of the voltage regulator circuit 10 within a desired operating region by adjusting the regulator's feedback resistance. The program logic ‘begins’ by monitoring the voltage regulator's output, e.g., V_{REG} in FIG. 2 or V_{REG2} in FIG. 4 (Step 100). The regulated voltage is compared with target voltage information, e.g., by the comparator 14 or other comparable circuitry (Step 102). Next, the comparator 14 determines whether the regulated voltage output is within a desired operating region as indicated by the target voltage information (Step 104). If the regulated voltage falls within the desired operating region, the regulator's feedback resistance remains unchanged (Step 106). Otherwise, the regulator's feedback resistance is adjusted accordingly to maintain its output voltage within the desired operating region (Step 108). Monitoring of the regulator's output continues unless instructed otherwise (Steps 110 and 112). The feedback resistance associated with the voltage regulator circuit 10 may be changed to a default value upon termination of the output monitoring or may remain unchanged.

The voltage regulator circuit 10 of the present invention may be included in any integrated circuit requiring internally-generated supply and/or reference voltages. For example, the voltage regulator circuit 10 may be included in memory devices such as Dynamic Random Access Memories (DRAMs), Static Random Access Memories (SRAMs), Magnetic Random Access Memories (MRAMs), and embedded memory devices, as well as microprocessors, microcontrollers, Application-Specific Integrated Circuits (ASICs), System-on-Chips (SoCs), etc.

With the above range of variations and applications in mind, it should be understood that the present invention is not limited by the foregoing description, nor is it limited by the accompanying drawings. Instead, the present invention is limited only by the following claims and their legal equivalents.

What is claimed is:

1. A method of operating a voltage regulator, comprising:
determining if a voltage output by the voltage regulator is within a desired operating region; and
adjusting a feedback resistance associated with the voltage regulator when the voltage output by the voltage regulator is outside the desired operating region.

2. The method of claim 1, wherein determining if a voltage output by the voltage regulator is within a desired operating region comprises:
comparing the voltage output by the voltage regulator to at least one predetermined limit; and
activating a signal when the comparison indicates that the voltage output by the voltage regulator is outside the desired operating region.

3. The method of claim 2, wherein activating a signal when the comparison indicates that the voltage output by the voltage regulator is outside the desired operating region comprises activating a counter.

4. The method of claim 3, wherein adjusting the feedback resistance associated with the voltage regulator comprises:
converting an output of the counter to a control signal; and
modifying the feedback resistance associated with the voltage regulator based on the control signal.

5. The method of claim 3, further comprising maintaining the counter in an active state until the voltage output by the voltage regulator is within the desired operating region.

6. The method of claim 1, wherein adjusting the feedback resistance associated with the voltage regulator comprises supplying a control signal to a variable resistor.

7. An integrated circuit, comprising:
a voltage regulator configured to output a voltage responsive to a reference voltage input and a feedback voltage; and
circuitry configured to determine if the voltage output by the voltage regulator is within a desired operating region and to adjust a feedback resistance associated with the voltage regulator when the voltage output by the voltage regulator is outside the desired operating region.

8. The integrated circuit of claim 7, wherein the circuitry is configured to determine if the voltage output by the voltage regulator is within a desired operating region by comparing the voltage output by the voltage regulator to at least one predetermined limit and activating a signal when the comparison indicates that the voltage output by the voltage regulator is outside the desired operating region.

9. The integrated circuit of claim 8, wherein the circuitry is configured to activate a signal when the comparison indicates that the voltage output by the voltage regulator is outside the desired operating region by activating a counter included in the integrated circuit.

10. The integrated circuit of claim 9, wherein the circuitry is configured to convert an output of the counter to a control signal and modify the feedback resistance associated with the voltage regulator based on the control signal.

11. The integrated circuit of claim 9, wherein the circuitry is further configured to maintain the counter in an active state until the voltage output by the voltage regulator is within the desired operating region.

12. The integrated circuit of claim 7, wherein the circuitry is configured to modify a control signal supplied to a variable resistor of the voltage regulator.

13. A method of operating a voltage regulator, comprising:
generating a regulated voltage;
comparing the regulated voltage to first and second predetermined limits;
activating a signal when the regulated voltage is outside a range indicated by the first and second predetermined limits;
determining a control signal based on the activated signal; and
supplying the control signal to a variable resistor of the voltage regulator.

14. The method of claim 13, wherein activating the signal comprises activating a counter.

15. The method of claim 14, wherein determining the control signal comprises determining the control signal based on an output of the counter.

16. The method of claim 14, further comprising maintaining the counter in an active state until the regulated voltage is within the range indicated by the first and second predetermined limits.

17. A voltage regulator circuit, comprising:
a voltage regulator configured to output a regulated voltage;
a comparator configured to compare the regulated voltage to first and second predetermined limits and to activate a signal when the regulated voltage is outside a range indicated by the first and second predetermined limits;
circuitry configured to determine a control signal based on the activated signal; and
a variable resistor configured to set a feedback resistance of the voltage regulator in response to the control signal.

18. The voltage regulator circuit of claim 17, wherein the circuitry comprises a counter and control logic.

19. The voltage regulator circuit of claim 18, wherein the comparator is configured to activate the signal by activating the counter.

20. The voltage regulator circuit of claim 19, wherein the control logic is configured to determine the control signal in response to an output of the counter.

21. The voltage regulator circuit of claim 19, wherein the comparator is further configured to maintain the counter in an active state until the regulated voltage is within the range indicated by the first and second predetermined limits.

22. The voltage regulator circuit of claim 17, wherein the voltage regulator comprises a first voltage regulation stage configured to generate a voltage responsive to a difference between a reference voltage input and a feedback voltage, and a second voltage regulation stage configured to generate the regulated voltage responsive to a difference between the voltage generated by the first voltage regulation stage and the regulated voltage.

23. The voltage regulator circuit of claim 22, wherein the variable resistor is configured to alter the feedback voltage in response to the control signal.

24. The voltage regulator circuit of claim 17, wherein the voltage regulator comprises an amplifier having an output driving an input of one or more transistors.

25. An integrated circuit including the voltage regulator circuit as claimed in claim 17.

26. A voltage regulator circuit, comprising:
a voltage regulator for outputting a regulated voltage;
a variable resistor associated with the voltage regulator for varying the regulated voltage output of the voltage regulator;
a control circuit operatively associated with the voltage regulator for varying the regulated voltage and generally controlling the regulated voltage such that the regulated voltage approximates a target voltage or falls within a target voltage range, the control circuit comprising:
a comparator for comparing the regulated voltage to the target voltage or target voltage range; and
wherein the control circuit varies the resistance of the variable resistor in response to a difference between the regulated voltage and the target voltage or target voltage range being equal to or greater than a predetermined limit, whereby the regulated voltage of the voltage regulator is controlled such that the regulated voltage approximates the target voltage or lies within the target voltage range.

27. The voltage regulator circuit of claim 26, wherein the control circuit further includes a counter and logic, the counter configured to output a count value corresponding to the difference between the regulated voltage and the target voltage or target voltage range being equal to or greater than a predetermined limit and the logic configured to program a control signal supplied to the variable resistor based on the count value.

28. A voltage regulator circuit, comprising:
a voltage regulator configured to output a regulated voltage;
a variable resistor associated with the voltage regulator and configured to vary a feedback voltage to the voltage regulator; and
means for comparing the regulated voltage to a target voltage or a target voltage range, and varying the resistance of the variable resistor when the difference between the regulated voltage and the target voltage or target voltage range is equal to or greater than a predetermined limit.

29. The voltage regulator circuit of claim 28, wherein the means for comparing the regulated voltage to a target voltage or target voltage range, and varying the resistance of the variable resistor comprises a comparator for comparing the regulated voltage with a target voltage or target voltage range, and circuitry for setting the variable resistor.

30. The voltage regulator circuit of claim 29, wherein the circuitry comprises a counter and control logic.

31. An integrated circuit including the voltage regulator circuit as claimed in claim 28.
